(19) United States
(12) Patent Application Publication
(10) Pub. No.: US 2009/0112393 A1
(43) Pub. Date: Apr. 30, 2009

(54) GENERATING VEHICLE TRIP EXPENSES AND PROJECTED MAINTENANCE NEEDS

(76) Inventors: Michael A. Maten, Troy, MI (US); Richard A. Johnson, Rochester Hills, MI (US)

Correspondence Address: Julia Church Dierker;Dierker & Associates, P.C., 3331 W. Big Beaver Road, Suite 109, Troy, MI, 48084-2813, US

(21) Appl. No.: 11/924,092

(22) Filed: Oct. 25, 2007

(51) Int. Cl. G06F 19/00; G01C 21/00

(52) U.S. Cl. 701/30; 701/202; 701/33; 707/3

(57) ABSTRACT

A method for generating vehicle trip expenses and projected maintenance needs is disclosed. The method includes determining a trip route via an Internet-enabled trip planning tool, and accessing vehicle performance information via the Internet-enabled trip planning tool. The vehicle performance information is selected from stored performance information, real-time performance information, and combinations thereof. The method further includes generating trip information based on the vehicle performance information and the trip route.

### TECHNICAL FIELD

The present disclosure relates generally to methods and systems for generating vehicle trip expenses and projected maintenance needs.

### BACKGROUND

Expenses and maintenance needs may be predicted for trip routes. In order to calculate such trip expenses and maintenance needs, vehicle performance data is generally used. As such, vehicle owners/users often rely on their own methods for tracking vehicle performance data. Such methods require the user to manually maintain vehicle performance records, and to manually input such data in order to perform the desired calculations.

### SUMMARY

A method for generating vehicle trip expenses and projected maintenance needs is disclosed. The method includes determining a trip route via an Internet-enabled trip planning tool, and accessing vehicle performance information via the Internet-enabled trip planning tool. The vehicle performance information is selected from stored performance information, real-time performance information, and combinations thereof. The method further includes generating trip information based on the vehicle performance information and the trip route.

### BRIEF DESCRIPTION OF THE DRAWINGS

Features and advantages of the present disclosure will become apparent by reference to the following detailed description and drawings, in which like reference numerals correspond to similar, though perhaps not identical components. For the sake of brevity, reference numerals or features having a previously described function may or may not be described in connection with other drawings in which they appear.

FIG. 1 is a schematic diagram depicting an example of a system for generating vehicle trip expenses and projected maintenance needs;

FIG. 2 is a flow diagram of an example of a method for generating vehicle trip expenses and projected maintenance needs; and

FIG. 3 is a schematic diagram depicting an example of the information flow for generating trip expenses and projected maintenance needs.

### DETAILED DESCRIPTION

Example(s) of the system and method disclosed herein advantageously provide users with a trip planning tool that retrieves and utilizes vehicle performance data. The trip planning tool is advantageously configured to obtain the vehicle performance data without the user manually inputting such data.

It is to be understood that, as used herein, the term “user” includes vehicle owners, operators, and/or passengers, and/or person(s) using the Internet-enabled trip planning tool. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct communication and indirect communication. As such, indirect communication may include communication between two components with additional component(s) located therebetween.

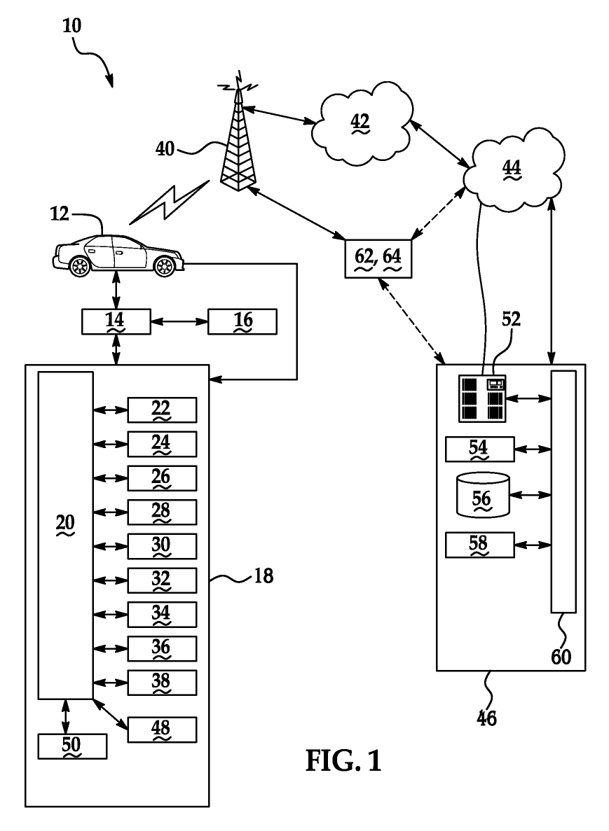

Referring now to FIG. 1, the system 10 includes a vehicle 12, a vehicle communications network 14, a telematics unit 18, a wireless communication system (including, but not limited to, one or more wireless carrier systems 40, one or more communication networks 42, and/or one or more land networks 44), and an Internet-enabled trip planning tool 62. In an example, the wireless communication system is a two-way radio frequency communication system. In another example, the wireless communication system also includes one or more call centers/service providers 46.

Generally, the vehicle 12 is a mobile vehicle with suitable hardware and software for transmitting and receiving voice and data communications. System 10 may include additional components suitable for use in telematics units 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an example, wireless carrier system 40 may be a cellular telephone system and/or any other suitable system for transmitting signals between the vehicle 12 and communications network 42. Further, the wireless carrier system 40 may include a cellular communication transceiver, a satellite communications receiver, a wireless computer network transceiver (a non-limiting example of which includes a Wide Area Network (WAN) transceiver), and/or combinations thereof.

Telematics unit 18 may include a processor 20 operatively coupled to a wireless modem 22, a location detection system 24 (a non-limiting example of which is a global positioning system (GPS)), an in-vehicle memory 26, a microphone 28, one or more speakers 30, an embedded or in-vehicle mobile phone 32, a real-time clock (RTC) 34, a short-range wireless communication network 36 (e.g. a Bluetooth® unit), a user interface 38, and/or a user interface panel 48.

It is to be understood that the telematics unit 18 may be implemented without one or more of the above listed components, such as, for example, speakers 30. Yet further, it is to be understood that the speaker(s) 30 may be a component of the vehicle audio system (which includes a receiver), which may, in addition to radio broadcasts, accept audio and other signals from the telematics unit 18. Telematics unit 18 may also include additional components and functionality as desired for a particular end use.

As an example, a user may communicate with the telematics unit 18 and/or with any equipment and system in operative communication therewith via the user interface panel 48. The user interface panel 48 is equipped with at least one input device such as, for example, a microphone, a button, a keyboard, a knob, a switch, and/or the like.

Processor 20 may be a micro controller, a controller, a microprocessor, a host processor, and/or a vehicle communications processor. In another example, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a global position satellite receiver, a radio triangulation system, a dead reckoning position system, and/or combinations thereof. In particular, a GPS provides accurate time and latitude and longitude coordinates of the vehicle 12 responsive to a GPS broadcast signal received from a GPS satellite constellation (not shown).

In-vehicle mobile phone 32 may be a cellular type phone, such as, for example an analog, digital, dual-mode, dual-band, multi-mode and/or multi-band cellular phone.

Also associated with processor 20 is the previously mentioned real time clock (RTC) 34, which provides accurate date and time information to the telematics unit 18 hardware and software components that may require date and time information. In one example, date and time information may be requested from the RTC 34 by other telematics unit 18 components. In other examples, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g., signals such as call signals) between telematics unit 18, wireless carrier system 40, and call center 46.

Further, processor 20 may generate and accept digital signals transmitted between the telematics unit 18 and the vehicle communication network 14, which is connected to various electronic modules in the vehicle 12. In one example, these digital signals activate the programming mode and operation modes within the electronic modules, as well as provide for data transfer between the electronic modules. In another example, certain signals from processor 20 may be translated into vibrations and/or visual alarms.

It is to be understood that software 50 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46. In one example, land network 44 is a public switched telephone network (PSTN). In another example, land network 44 is an Internet Protocol (IP) network. In still other examples, land network 44 is a wired network, an optical network, a fiber network, another wireless network, and/or any combinations thereof. The land network 44 may be connected to one or more landline telephones. It is to be understood that the communications network 42 and the land network 44 connect the wireless carrier system 40 to the call center 46.

Call center 46 may contain one or more data switches 52, one or more communication services managers 54, one or more communication services databases 56 containing subscriber profile records and/or subscriber information, one or more communication services advisors 58 and one or more network systems 60.

It is to be understood that, although a service provider may be located at the call center 46, the call center 46 is a separate and distinct entity from the service provider. In an embodiment, the service provider is located remote from the call center 46. A service provider provides the user with telephone and/or Internet services. In an embodiment, the service provider is a wireless carrier (such as, for example, Verizon Wireless®, Cingular®, Sprint®, etc.). It is to be understood that the service provider may interact with the call center 46 to provide service(s) to the user.

Switch 52 of call center 46 may transmit voice or data transmissions from call center 46, and may receive voice or data transmissions from telematics unit 18 in vehicle 12 through wireless carrier system 40, communications network 42, and land network 44. As such, a connection between the telematics unit 18 and the call center 46 may be established via the wireless carrier system 40, communications network 42 and/or land network 44. Switch 52 may receive data transmissions from, or send data transmissions to, one or more communication service managers 55 via one or more network systems 60.

Call center 46 may contain one or more service advisors 58. In one embodiment, a service advisor 58 is human. In another embodiment, a service advisor 58 is an automaton. It is to be understood that the service advisor 58 may be located at the call center 46 or may be located remote from the call center 46 while communicating therethrough.

Communication may be accomplished via voice mode or data mode. Voice mode communications generally occur between the user and the service advisor 58 or some other third party. Data mode communications generally occur between the telematics unit 18 and components (e.g., communication services databases 56) of the call center 46 or service provider. In an embodiment, the communication is established via a connection extending (e.g., via the wireless communication system) between the telematics unit 18 and the call center 46.

As previously stated, the system 10 also includes an Internet-enabled trip planning tool 62 that is in selective communication with both the vehicle 12 and the call center 46. In a non-limiting example, the Internet-enabled trip planning tool 62 is connected to the vehicle 12 and/or to the call center 46 via the wireless communication system. In one example, the Internet-enabled trip planning tool 62 is supported and hosted by a server 64 that is capable of communicating with both the vehicle 12 and the call center 26. In another example, the server 64 may send information to and receive information from the call center 46, and the call center 46 may then communicate with vehicle 12.

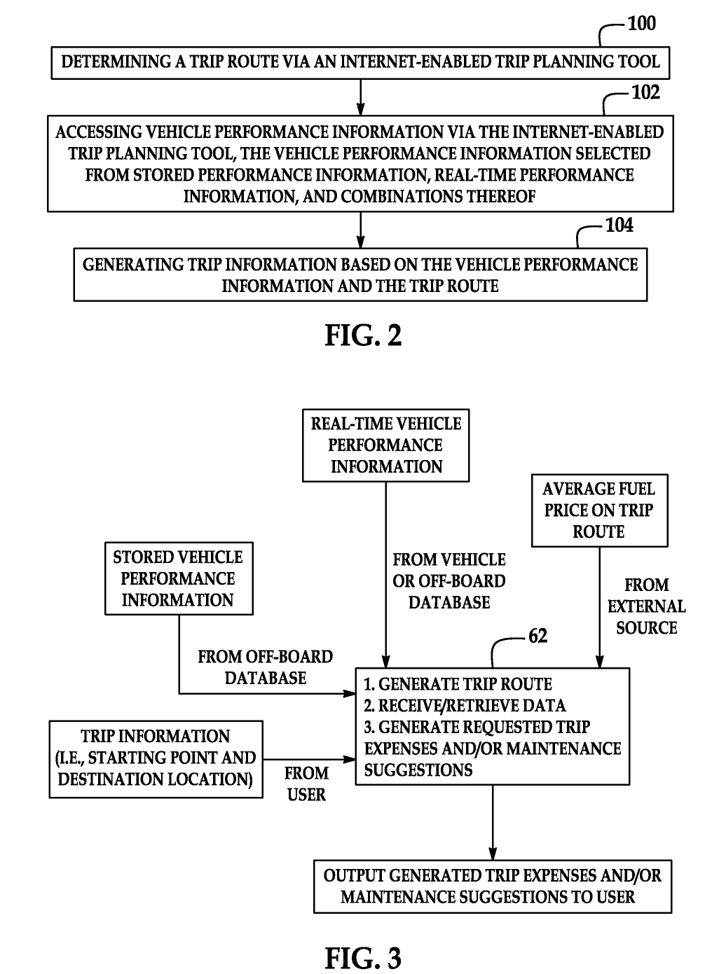

Referring now to FIG. 2, an example of the method for generating vehicle trip expenses and projected maintenance needs is depicted. The method generally includes determining a trip route via the Internet-enabled trip planning tool 62, as shown at reference numeral 100; accessing vehicle performance information via the Internet-enabled trip planning tool 62, as shown at reference numeral 102; and generating trip information based on the vehicle performance information and the trip route, as shown at reference numeral 104.

Referring now to FIGS. 2 and 3 together, the method disclosed in FIG. 2 will be described in further detail, where FIG. 3 illustrates the flow of data/information. Generally, a user accesses the Internet-enabled trip planning tool 62 via a computer or other electronic device (e.g., desktop, notebook, mobile phone, or personal digital assistant) configured to access the Internet. In an example, the computer or other electronic device includes, or is in communication with, an input device (e.g., a keyboard and/or mouse) and a display (e.g., a monitor and/or one or more speakers). It is to be understood that the communication between the computer or other electronic device and the server 64 hosting the Internet-enabled trip planning tool 62 may be wired and/or wireless.

The computer or other electronic device is generally at a location that is remote from the vehicle 12. The user may access a personalized account at the Internet-enabled trip planning tool 62 by inputting user-specific information. The user specific information may include, for example, the user's name, a password, an account number, and/or any other identifying information. It is to be understood that the personalized account information may be stored and/or accessed by the server 64 or by the call center 46.

Upon recognizing the user, the server 64 supporting the tool 62 is able to communicate with one or more vehicles 12 associated with the user's account, or with the call center 46 associated with the user's account.

Once the user is granted access to his/her account, the trip planning tool 62 prompts the user to enter or select a starting point and a destination location for the trip. The starting point and destination location may be manually entered by the user, or may be selected from a list of predetermined starting and/or destination locations operatively stored with/at/in: 1) the user's computer or other electronic device; 2) the user's account (via server 64); and/or 3) the call center 46. In the latter two examples, the list of starting points and/or destination locations is stored at a location remote from the computer or other electronic device being used to access the Internet-enabled trip planning tool 62. As such, the list may be accessible to a user from any device capable of accessing the trip planning tool 62. In another example, the list is stored locally at the device where the starting positions and/or destination locations were previously input or detected. In such an example, an abbreviated list may be accessible at any single device, the abbreviated list including those starting points or destination locations that were input or detected at that particular device.

The list of predetermined starting points and/or destination locations may be composed of locations previously entered by the user and saved in his/her account. The starting point may also be the user's garage address which is stored in a database 56, for example, located at the call center 46. If the user selects the garage address, the trip planning tool 62 communicates with the call center 46 to retrieve such information. Other starting points may be, for example, current vehicle latitude and longitude coordinates (retrieved from the vehicle location detection system 24), place names (such as points of interest), and/or the like.

It is to be understood that the list of predetermined destination locations may also be non-user specific, and may be generated via an entity operating the trip-planning tool 62. Lists of major cities, attractions, theaters, stadiums/arenas, and/or the like may be available to a user to select from the list of predetermined destination location. Such lists may be organized via geographic areas.

In one example, the user may enter the starting point and/or destination location as a complete or partial address and/or as a complete or partial name. If the entry is a partial address or partial name, the server 64 may assume a complete name or address therefrom, or may prompt the user to select one or more complete names or addresses from one or more that are provided to the user.

Using the entered/selected starting point and destination location, the trip planning tool 62 generates a trip route for the user.

In one example, the trip planning tool 62 then inquires whether the user would like to generate trip information (i.e., calculate trip expenses and/or to project maintenance needs). In another example, the user requests the trip planning tool 62 to calculate trip expenses and/or to project maintenance needs. In either example, the trip planning tool 62 may include some icon or other input area which allows the user to select/request this feature.

In order to calculate trip expenses and/or project maintenance needs, the trip planning tool 62 needs to know which vehicle 12 the user will be taking on the trip. The user may select the vehicle 12 from a list of vehicle(s) associated with the user and stored within the user's account. If the user has recently purchased a new vehicle 12 and has initiated the communication system, he/she may input the vehicle information (e.g., vehicle identification number (VIN), mobile identification number (MIN), etc.) into the Internet-enabled trip planning tool 62, which in turn will attempt to communicate with the vehicle 12. The trip planning tool 62 may also include personalized graphical and/or textual indicia (not shown) representing the vehicle 12 associated with the user.

The trip planning tool 62 is capable of accessing vehicle performance information from the vehicle 12 (either directly or via the call center 46), and/or from an off-board database 56 maintained by the call center 46. The vehicle performance information may include stored performance information, real-time performance information, or combinations thereof. Examples of such information include, but are not limited to average vehicle fuel economy data, remaining oil life data, vehicle odometer data, vehicle coolant level data, remaining brake life data, or the like, or combinations thereof. It is to be understood that vehicle performance information may also include other diagnostic and maintenance information.

In one example, the call center 46 periodically collects fuel economy data and oil life data from the vehicle 12 (e.g., via a vehicle upload function of the telematics unit 18). In some examples, the call center 46 prompts the vehicle 12 to transmit such data, and in other examples, the vehicle 12 automatically uploads such information to the call center 46 (e.g., when a user changes the oil, the telematics unit 18 transmits an event or an oil life reset indication and the then-current odometer reading to the call center 46).

The call center 46 then analyzes the fuel and/or oil data to determine the vehicle's average fuel economy and remaining oil life, respectively. Analysis may be accomplished via statistical methods, such as an average over time and linear regression. It is to be understood that the analysis is updated each time the fuel and/or oil data is collected.

The analyzed data is then stored in the user's profile in the off-board database 56 at the call center 46. Generally, the date on which the data is stored is noted in the database 56. Thus, when the data is retrieved, the trip planning tool 62 may determine how current the data is.

The call center 46 may also periodically collect vehicle odometer data, vehicle coolant level data, and remaining brake life data. Generally, such data is considered to be real-time performance information, in part because the data may become quickly out-dated due to its frequently changing status. As such, when such data is collected, the database 56 stores the data in a temporary cache, which, after a predetermined time, deletes the data or marks the data as being historic. In one example, the predetermined time is 24 hours, and in another example, the predetermined time is 48 hours. It is to be understood that the predetermined time may be set at any suitable period of time, taking into consideration the type of data that is collected, the frequency at which such data changes or is likely to change, and/or the like. The data may also be stored in database 56 for later processing. In one example, the data may be purged when the quantity of data reaches a threshold, such as a predetermined number of kilobytes or megabytes. In this example, older data is purged before newer data.

The periodic collection of data may occur at any suitable time interval. The time intervals for data collection may be as frequent as daily, weekly, monthly, bimonthly, etc. Such predetermined intervals may be set by the call center 46, the vehicle user, and/or a combination thereof. For example, if a user travels lengthy distances by vehicle 12 often, he/she may request that the call center 46 collect some vehicle performance data (e.g., vehicle odometer data, vehicle coolant level data, and remaining brake life data) on a daily basis, and other vehicle performance data (e.g., fuel economy data and oil life data) on a weekly basis.

It is to be understood that data may also be collected in response to a trigger event. In one example, the trigger event may be initiated by a vehicle occupant by accessing a user interface 38. In another example, the trigger event may be initiated by the vehicle 12 after a predetermined number of miles and/or kilometers have elapsed. In yet another example, the trigger event may be initiated by call center 46.

As previously mentioned, the trip planning tool 62 is capable of accessing the vehicle performance information. In one example, the trip planning tool 62 receives information from the off-board database 56, and in another example, the trip planning tool 62 receives information from the vehicle 12. In still another example, the trip planning tool 62 receives some information from the off-board database 56 and other information from the vehicle 12.

To access the vehicle performance information, the trip planning tool 62 may contact the call center 46 via the two-way wireless carrier system 40 and communications network 42, and request the desirable vehicle performance data for the vehicle 12. The trip planning tool 62 may request all stored data or a particular type of data (e.g., fuel economy data). This request may depend, at least in part, on the initial request made by the user for trip information.

In response, the call center 46 retrieves the requested data from the database 56, and transmits the retrieved stored data to the trip planning tool 62. The database 56 may also transmit the date upon which the data was stored. This enables the trip planning tool 62 to determine if the received stored vehicle performance information is up-to-date enough to generate the requested trip expenses and/or maintenance needs for the user.

It is to be understood that the trip planning tool 62 may also contact the vehicle 12 (directly or indirectly via the call center 46) to obtain real-time (as opposed to stored) performance information from the vehicle 12. In one example, the trip planning tool 62 contacts the vehicle 12 directly via the two-way communication system. In another example, the trip planning tool 62 contacts the call center 46 via the two-way communication system, and the call center 46 then contacts the vehicle 12 to obtain the requested real-time performance information. In an instance of the latter example, the trip planning tool 62 may contact the call center 46 requesting all stored data, and the call center 46 may have out-dated (e.g., over 24 hours old) vehicle odometer data. The call center 46 may then attempt to contact the vehicle 12 to obtain the real-time odometer data for the trip planning tool 62.

Average fuel economy data and remaining oil life data is, in one example, calculated at the call center 46. On some makes and models however, the average fuel economy and remaining oil life data is available directly from the vehicle 12 (which includes sensors and other electronics for obtaining and calculating such data). If the trip planning tool 62 is able to establish direct or indirect communication with the vehicle 12, it may receive then-current or real-time vehicle odometer data, vehicle coolant level data, remaining brake life data, and in some examples average fuel economy and/or remaining oil life data from the vehicle 12.

Generally, the trip planning tool 62 may establish communication with the vehicle 12 when the telematics unit 18 of the vehicle 12 is in “awake” mode. In one example, if the vehicle is in “sleep” mode, the trip planning tool 62 is informed that the connection may not be established at that particular time. In this example, a pending communication request may be generated, and when the vehicle 12 transits from the “sleep” mode to the “awake” mode, the communication request is issued to the vehicle 12 soliciting a response to the communication request.

When the trip planning tool 62 has obtained the requested vehicle performance data, the trip planning tool 62 utilizes the data to calculate trip expenses and/or to project maintenance needs for the trip. As previously stated, the information generated may be based on the request of the user. As non-limiting examples, the trip planning tool 62 may calculate the fuel cost along the trip route, and/or may determine whether the oil life, coolant level, and/or brake life is/are sufficient for the vehicle 12 to complete the trip route without maintenance.

In calculating the fuel cost of the trip, the trip planning tool 62 utilizes the received average fuel economy data for the vehicle 12 and an average fuel cost along the trip route. The average fuel cost along the trip route may be determined by querying a database for then-current fuel costs in one or regions encompassing the trip route. For example, if the trip route is from Detroit, Mich. to Chicago, Ill., the trip planning tool 62 may query one or more external sources/databases, such as consumer oriented Websites that provide up-to-date, national gas pricing information, for fuel prices in Detroit, Mich., Jackson, Mich., Kalamazoo, Mich., Gary, Ind., and Chicago Ill. to determine the fuel prices in different cities along the trip route. The trip planning tool 62 then, in one example, averages the prices to determine the average fuel cost along the trip route. The trip planning tool 62 then, in one example, multiplies the average vehicle fuel economy data by the trip distance and the average fuel cost along the trip route to calculate the trip fuel expense. In another example, the trip planning tool 62 may utilize a linear regression technique based on historical data to determine the fuel cost along the trip route.

In projecting maintenance needs, the trip planning tool 62 utilizes the received oil life, coolant level, and/or brake life information in conjunction with the distance of the trip route. In one example, the remaining life of a vehicle 12 component may be known, such as the brake life, determined by units of distance. If the distance of the trip exceeds the distance remaining for the brake life to expire, the trip planning tool 62 may notify the subscriber of the pending brake life expiration.

After determining whether the oil life, coolant level, and/or brake life is sufficient to complete the trip route, the trip planning tool 62 generates a maintenance suggestion indicating when (i.e., pre-trip, during-trip or post-trip) the user should have an oil change, should fill up the coolant, and/or should have the brakes changed.

Any trip information generated via the trip planning tool 62 may be transmitted to the user via the Internet-enabled trip planning tool 62. It is to be understood that the user may print the information, email the information to himself/herself or another party, store the information in his/her account for later use, or combinations thereof.

While several embodiments have been described in detail, it will be apparent to those skilled in the art that the disclosed embodiments may be modified. Therefore, the foregoing description is to be considered exemplary rather than limiting.

1. A method for generating vehicle trip expenses and projected maintenance needs, the method comprising:
determining a trip route via an Internet-enabled trip planning tool;
accessing vehicle performance information via the Internet-enabled trip planning tool, the vehicle performance information selected from stored performance information, real-time performance information, and combinations thereof; and
generating trip information based on the vehicle performance information and the trip route.

2. The method as defined in claim 1 wherein prior to accessing, the method further comprises:
collecting the vehicle performance information from the vehicle;
analyzing the collected vehicle performance information; and
storing the analyzed vehicle performance information in an off-board database.

3. The method as defined in claim 2 wherein collecting is accomplished via a vehicle data upload function of a vehicle telematics unit.

4. The method as defined in claim 2 wherein collecting occurs at predetermined intervals.

5. The method as defined in claim 2 wherein the off-board database is located at a call center.

6. The method as defined in claim 1 wherein the vehicle performance information is selected from average vehicle fuel economy data, remaining oil life data, then-current vehicle odometer data, vehicle coolant level data, remaining brake life data, and combinations thereof.

7. The method as defined in claim 6 wherein generating includes:
determining an average fuel cost along the trip route; and
calculating a trip fuel expense for the vehicle based on the average vehicle fuel economy data and the average fuel cost.

8. The method as defined in claim 7 wherein determining the average fuel cost along the trip route includes:
querying a database for fuel costs in at least one region encompassing the trip route; and
averaging the fuel costs.

9. The method as defined in claim 7 wherein calculating the trip fuel expense includes multiplying the average vehicle fuel economy data by a distance of the trip route and the average fuel cost along the trip route.

10. The method as defined in claim 6 wherein generating includes:
determining if at least one of the remaining oil life data, the vehicle coolant level data, the remaining brake life data, or combinations thereof is sufficient for the vehicle to complete the trip route; and
generating one or more maintenance suggestions based on the determining

11. The method as defined in claim 10 wherein the one or more maintenance suggestions is selected from a pre-trip oil change, a during-trip oil change, a post-trip oil change, a pre-trip brake change, a during-trip brake change, a post-trip brake change, a pre-trip coolant fill up, a during-trip coolant fill up, a post trip coolant fill up, and combinations thereof.

12. The method as defined in claim 1 wherein accessing real-time performance information includes:
contacting the vehicle via the Internet-enabled trip planning tool; and
uploading the real-time performance information from the vehicle to the Internet-enabled trip planning tool.

13. The method as defined in claim 12 wherein contacting the vehicle includes:
contacting a call center via the Internet-enabled trip planning tool; and
contacting the vehicle via the call center.

14. The method as defined in claim 1, further comprising presenting the trip information to a user via the Internet-enabled trip planning tool.

15. The method as defined in claim 1 wherein prior to determining the trip route, the method further comprises:
entering or selecting a trip destination location via the Internet-enabled trip planning tool; and
determining a trip starting point from a user's garage address stored in an off-line database or from an entered or selected starting point.

16. A system for generating vehicle trip expenses and projected maintenance needs, the system comprising:
a vehicle configured to upload vehicle performance information, wherein the vehicle performance information is selected from stored performance information, real-time performance information, and combinations thereof;
an off-board database configured to receive and store at least some of the uploaded vehicle performance information; and
an Internet-enabled trip planning tool configured to receive the vehicle performance information in order to generate trip information.

17. The system as defined in claim 16, further comprising a call center at which the off-board database is located.

18. The system as defined in claim 16, further comprising a call center configured to retrieve the real-time performance information from the vehicle and to send the real-time performance information to the Internet-enabled program.

19. The system as defined in claim 16 wherein the vehicle performance information is selected from average vehicle fuel economy data, remaining oil life data, then-current vehicle odometer data, vehicle coolant level data, remaining brake life data, and combinations thereof.

20. The system as defined in claim 16, further comprising a telematics unit operatively connected to the vehicle, wherein the telematics unit has a vehicle data upload function that collects and transmits the vehicle performance information.

21. A method for generating vehicle trip expenses and projected maintenance needs, the method comprising:
entering or selecting a trip route destination via an Internet-enabled trip planning tool;
determining a trip starting point from a user's garage address or from an entered or selected starting point;
determining, via the Internet-enabled trip planning tool, a trip route based on the trip route destination and the trip starting point;
accessing stored average fuel economy data and remaining oil life data for a predetermined vehicle via the Internet-enabled trip planning tool;
calculating a trip fuel expense based on the average fuel economy data and an average fuel cost along the trip route; and
generating an oil change suggestion based on the remaining oil life data and the trip route.

22. The method as defined in claim 21 wherein the predetermined vehicle is associated with a user account used to access the Internet-enabled trip planning tool.
